(19) United States
(12) Patent Application Publication
(10) Pub. No.: US 2026/0075625 A1
(43) Pub. Date: Mar. 12, 2026

(54) INTER-USER EQUIPMENT COORDINATION IN SIDELINK

(71) Applicant: QUALCOMM INCORPORATED, San Diego, CA (US)

(72) Inventors: Shaozhen GUO, Beijing (CN); Jing SUN, San Diego, CA (US); Changlong XU, Beijing (CN); Chih-Hao LIU, San Diego, CA (US); Xiaoxia ZHANG, San Diego, CA (US); Luanxia YANG, Beijing (CN); Siyi CHEN, Beijing (CN)

(21) Appl. No.: 19/102,363

(22) PCT Filed: Sep. 28, 2022
(86) PCT No.: PCT/CN2022/121992

§ 371 Date: Feb. 7, 2025

(51) Int. Cl. H04W 72/25; H04L 27/26; H04W 74/00

(52) U.S. Cl. CPC H04W 72/25; H04L 27/2678; H04W 74/002

(57) ABSTRACT

Methods, systems, and devices for wireless communications are described. In sidelink communications, multiple user equipments (UE) smay access and utilize communications resources, sense other UEs, and coordinate utilization of resources. A conflict may occur between resource reservations of two UEs. Described techniques provide for a determined transmission by a first UE of a conflict indication message to one UEs. The first UE may account for one or more channel access parameters affecting the likelihood of the second UE and the third UE being able to access the reserved reservations when determining to which UE to transmit the conflict indication message (e.g., which UE is the UE-B). The first channel access parameter and the second channel access parameter may be based on a channel occupancy time, a channel sensing duration, a cyclic prefixed extension, and/or a number of retransmissions, associated with the first resource reservation and the second resource reservation.

### CROSS REFERENCE

This application is a 371 National Stage of PCT Application No. PCT/CN2022/121992, filed on Sep. 28, 2022, entitled “INTER-USER EQUIPMENT COORDINATION IN SIDELINK,” and assigned to the assignee hereof. The disclosure of the prior Application is considered part of and is incorporated by reference into this Patent Application.

### FIELD OF TECHNOLOGY

The following relates to wireless communications, including inter-user equipment coordination in sidelink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support inter-user equipment (UE) coordination in sidelink. In sidelink communications, multiple UEs may access and utilize communications resources, sense other UEs, and coordinate utilization of resources. In some instances, a conflict may occur between resource reservations of two or more of UEs. The described techniques provide for a determined transmission by a first UE (the sensing UE, referred to as the UE-A) of a conflict indication message to one of the two or more UEs. When the indicated transmission priorities for the resource reservations for the second UE and the third UE are the same, the first UE may account for one or more channel access parameters affecting the likelihood of the second UE and the third UE being able to access the reserved reservations when determining to which UE to transmit the conflict indication message (e.g., which UE is the UE-B). The first channel access parameter and the second channel access parameter may be based on a channel occupancy time (COT), a channel sensing duration, a cyclic prefixed extension (CPE), and/or a number of retransmissions, associated with the first resource reservation and the second resource reservation.

A method for wireless communications at a first UE is described. The method may include receiving, from a second UE, a first sidelink control information (SCI) message indicative of a first resource reservation and a first parameter, receiving, from a third UE, a second SCI message indicative of a second resource reservation and a second parameter, where the second resource reservation at least partially overlaps with the first resource reservation, and transmitting, to one of the second UE or the third UE, a conflict indication message in accordance with a conflict reporting scheme indicating to transmit the conflict indication message to one of the second UE or the third UE based on the first parameter and the second parameter.

An apparatus for wireless communications at a first UE is described. The apparatus may include a processor, memory coupled with the processor, and instructions stored in the memory. The instructions may be executable by the processor to cause the apparatus to receive, from a second UE, a first SCI message indicative of a first resource reservation and a first parameter, receive, from a third UE, a second SCI message indicative of a second resource reservation and a second parameter, where the second resource reservation at least partially overlaps with the first resource reservation, and transmit, to one of the second UE or the third UE, a conflict indication message in accordance with a conflict reporting scheme indicating to transmit the conflict indication message to one of the second UE or the third UE based on the first parameter and the second parameter.

Another apparatus for wireless communications at a first UE is described. The apparatus may include means for receiving, from a second UE, a first SCI message indicative of a first resource reservation and a first parameter, means for receiving, from a third UE, a second SCI message indicative of a second resource reservation and a second parameter, where the second resource reservation at least partially overlaps with the first resource reservation, and means for transmitting, to one of the second UE or the third UE, a conflict indication message in accordance with a conflict reporting scheme indicating to transmit the conflict indication message to one of the second UE or the third UE based on the first parameter and the second parameter.

A non-transitory computer-readable medium storing code for wireless communications at a first UE is described. The code may include instructions executable by a processor to receive, from a second UE, a first SCI message indicative of a first resource reservation and a first parameter, receive, from a third UE, a second SCI message indicative of a second resource reservation and a second parameter, where the second resource reservation at least partially overlaps with the first resource reservation, and transmit, to one of the second UE or the third UE, a conflict indication message in accordance with a conflict reporting scheme indicating to transmit the conflict indication message to one of the second UE or the third UE based on the first parameter and the second parameter.

In some examples of the method, apparatuses, and non-transitory computer-readable medium described herein, transmitting the conflict indication message may include operations, features, means, or instructions for transmitting the conflict indication message to the second UE based on a first probability of channel access to the first resource reservation being less than a second probability of channel access to the second resource reservation in accordance with the conflict reporting scheme, where the first parameter corresponds to the first probability of channel access to the first resource reservation, and where the second parameter corresponds to the second probability of channel access to the second resource reservation.

In some examples of the method, apparatuses, and non-transitory computer-readable medium described herein, the first SCI message indicates a first priority, the second SCI message indicates a second priority equal to the first priority, and transmitting the conflict indication message may be based on the second priority being equal to the first priority.

In some examples of the method, apparatuses, and non-transitory computer-readable medium described herein, where the first SCI message indicates the first resource reservation is outside a first COT for the second UE, and where the second SCI message indicates the second resource reservation is within a second COT for the third UE, transmitting the conflict indication message may include operations, features, means, or instructions for transmitting the conflict indication message to the second UE based on the first resource reservation being outside the first COT and the second resource reservation being within the second COT in accordance with the conflict reporting scheme.

In some examples of the method, apparatuses, and non-transitory computer-readable medium described herein, where the first SCI message indicates a first channel access type associated with a first channel sensing duration, and where the second SCI message indicates a second channel access type associated with a second channel sensing duration, transmitting the conflict indication message may include operations, features, means, or instructions for transmitting the conflict indication message to the second UE based on the first channel sensing duration being longer than the second channel sensing duration in accordance with the conflict reporting scheme.

In some examples of the method, apparatuses, and non-transitory computer-readable medium described herein, where the first SCI message indicates a first CPE associated with the first resource reservation, and where the second SCI message indicates a second CPE associated with the second resource reservation, transmitting the conflict indication message may include operations, features, means, or instructions for transmitting the conflict indication message to the second UE based on the first CPE being shorter than the second CPE in accordance with the conflict reporting scheme.

In some examples of the method, apparatuses, and non-transitory computer-readable medium described herein, where the first SCI message indicates a first hybrid automatic repeat request (HARQ) retransmission number associated with the first resource reservation, and where the second SCI message indicates a second HARQ retransmission number associated with the second resource reservation, transmitting the conflict indication message may include operations, features, means, or instructions for transmitting the conflict indication message to the second UE based on the first HARQ retransmission number being less than the second HARQ number in accordance with the conflict reporting scheme.

In some examples of the method, apparatuses, and non-transitory computer-readable medium described herein, the second resource reservation at least partially overlaps with the first resource reservation in the time domain, the frequency domain, or a combination thereof.

In some examples of the method, apparatuses, and non-transitory computer-readable medium described herein, transmitting the conflict indication message may include operations, features, means, or instructions for transmitting the conflict indication message via a sidelink feedback channel.

Some examples of the method, apparatuses, and non-transitory computer-readable medium described herein may further include operations, features, means, or instructions for receiving a sidelink message from the third UE in accordance with the second resource reservation, where transmitting the conflict indication message includes transmitting the conflict indication message to the second UE.

Some examples of the method, apparatuses, and non-transitory computer-readable medium described herein may further include operations, features, means, or instructions for receiving control signaling indicating the conflict reporting scheme.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports inter-user equipment (UE) coordination in sidelink in accordance with one or more aspects of the present disclosure.

FIG. 2 illustrates an example of a process flow that supports inter-UE coordination in sidelink in accordance with one or more aspects of the present disclosure.

FIG. 3 illustrates an example of a wireless communication system that supports inter-UE coordination in sidelink in accordance with one or more aspects of the present disclosure.

FIG. 4 illustrates an example of a resource diagram in accordance with one or more aspects of the present disclosure.

FIG. 5 illustrates an example of a process flow that supports inter-UE coordination in sidelink in accordance with one or more aspects of the present disclosure.

FIGS. 6 and 7 show block diagrams of devices that support inter-UE coordination in sidelink in accordance with one or more aspects of the present disclosure.

FIG. 8 shows a block diagram of a communications manager that supports inter-UE coordination in sidelink in accordance with one or more aspects of the present disclosure.

FIG. 9 shows a diagram of a system including a device that supports inter-UE coordination in sidelink in accordance with one or more aspects of the present disclosure.

FIGS. 10 and 11 show flowcharts illustrating methods that support inter-UE coordination in sidelink in accordance with one or more aspects of the present disclosure.

### DETAILED DESCRIPTION

Some wireless communication systems support sidelink communications between user equipments (UE)s. In sidelink communications, multiple UEs (e.g., two or more) may access and utilize communications resources, sense other UEs, and/or coordinate utilization of resources. A resource reservation conflict may occur when two or more UEs reserve at least partially overlapped resources in time and frequency. A first UE (e.g., UE-A) may sense reservations from other UEs, such as a second UE and a third UE, that may result in conflicting resource reservations. The first UE may determine these reservations by detecting or sensing sidelink control information (SCI) messages transmitted by the second UE and the third UE. The SCI messages may indicate the reservation information (e.g., the time (e.g., slot) and/or frequencies (e.g., subchannel) of the reserved resources) and whether the UEs are able to receive conflict indication messages. The SCI messages may indicate transmission priorities for the resource reservations for the second UE and the third UE.

The first UE may select one of the second UE or the third UE as the UE-B to transmit the conflict indication message to, which may cause the selected UE to select and reserve a new resource (e.g., associated with a different time and/or frequency range). When the UEs have different transmission priorities for the overlapping reserved resource, the first UE may select to send the conflict indication message to the lower priority UE. However, if the indicated transmission priorities are the same, the first UE may select either the second UE or the third UE as the UE-B to reselect its respective resource, potentially at random. If the sidelink communications are in an unlicensed spectrum, the UEs may perform listen before talk (LBT) prior to transmitting on the reserved resources. The LBT procedures for the UEs may have different probabilities of success for transmission over the respective channels based on multiple channel access parameters (e.g., channel occupancy time (COT), cyclic prefix extension (CPE), channel sensing duration, and/or number of retransmissions). Accordingly, random selection by the first UE of one of the second or third UEs may result in inefficiency due to unused resources due to the different probabilities of success.

Aspects of the disclosure relate to selection by first UE (e.g., UE-A) of a UE-B between or among multiple UEs, such as the second UE or the third UE based on one or more of the channel access parameters (e.g., COT, CPE, channel sensing duration, and number or retransmissions). The channel access parameters may be indicated in the SCI messages that reserve the overlapping resource(s). The first UE may transmit a conflict indication message to the determined UE-B, and the UE-B may select a different resource based on the conflict indication message.

Aspects of the disclosure are initially described in the context of wireless communications systems. Aspects of the disclosure are further illustrated by and described with reference to apparatus diagrams, system diagrams, and flowcharts that relate to inter-UE coordination in sidelink.

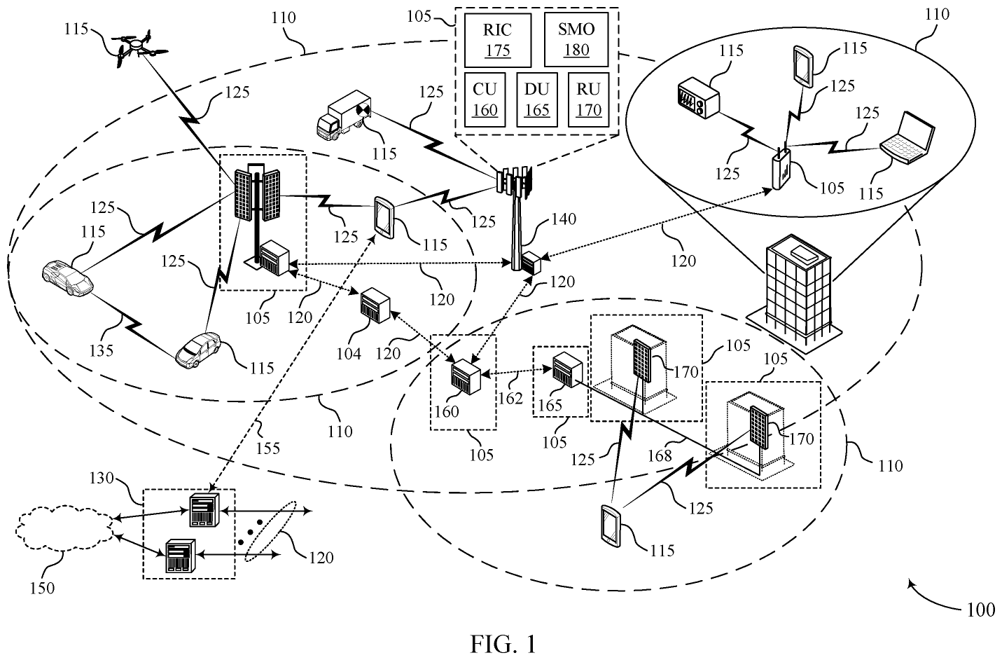

FIG. 1 illustrates an example of a wireless communications system 100 that supports inter-UE coordination in sidelink in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support inter-UE coordination in sidelink as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support sidelink communications between the UEs 115. Generally, in sidelink communications, multiple UEs 115 may access and utilize communication resources, sense other UEs, and coordinate utilization of resources. In some instances, a conflict may occur between reservations of two or more of the UEs 115, for example, a conflict involving resources. For example, two or more UEs may reserve communication resources during the same time and/or over the same frequency range. A first UE 115 (e.g., UE-A) may sense reservations from other UEs 115, such as a second UE 115 and a third UE 115, that may have conflicting resource reservations. The first UE 115 may determine the reservations from the second UE 115 and the third UE 115 by detecting or sensing SCI messages transmitted by the second UE 115 and the third UE 115. The SCI messages may indicate reservation information (e.g., time frame and/or frequencies for accessing the reserved resources) and whether the UEs 115 are able to receive conflict indication messages, as well as indicate transmission priorities for the second UE 115 and the third UE 115, respectively. The first UE may select one of the UEs 115 as a UE-B to change the reservation for that UE by sending it a conflict indication message. The UE 115 that receives the conflict indication message (e.g., the UE-B) may select a new resource reservation. Specifically, if one of the overlapping reservations indicates a lower priority, the first UE 115 may select to send the conflict indication message to that UE 115. If the indicated transmission priorities for the overlapping reservations are the same, however, the first UE 115 may select either the second UE 115 or the third UE 115. If the sidelink communications are in unlicensed spectrum, the UEs 115 may perform LBT prior to transmitting on the reserved resources. The LBT procedures for the UEs 115 may have different probabilities of success based on multiple parameters (e.g., COT, CPE, channel sensing duration, and/or number of retransmissions). Accordingly, random selection by the first UE 115 of one of the second UE 115 or the third UE 115 may be inefficient.

Multiple UEs 115 may access and utilize communications resources, sense other UEs 115, and/or coordinate utilization of resources. A resource reservation conflict may occur when two or more UEs 115 reserve resources during the same time and/or over the same frequency range. A first UE (e.g., UE-A) may sense reservations from other UEs 115, such as a second UE 115 and a third UE, that may have the conflicting resource reservations. The first UE 115 may determine these reservations by detecting or sensing SCI messages transmitted by the second UE 115 and the third UE 115. The SCI messages may indicate the reservation information (e.g., the time (e.g., slot) and/or frequencies (e.g., subchannel) of the reserved resources) and whether the UEs are able to receive conflict indication messages. The SCI messages may indicate transmission priorities for the resource reservations for the second UE 115 and the third UE 115. The first UE 115 may select one of the UEs 115 as the UE-B 115 to transmit the conflict indication message to, which may cause the selected UE to select and reserve a new resource (e.g., associated with a different time and/or frequency range). When the UEs 115 have different transmission priorities for the overlapping reserved resource, the first UE 115 may select to send the conflict indication message to the lower priority UE 115.

If the sidelink communications are in an unlicensed spectrum, the UEs may perform LBT prior to transmitting on the reserved resources. The LBT procedures for the UEs 115 may have different probabilities of success for transmission over the respective channels based on multiple channel access parameters (e.g., COT, CPE, channel sensing duration, and/or number of retransmissions). When the transmission priorities for the second UE 115 and the third UE 115 are the same, the first UE 115 may account for the parameters affecting the likelihood of the second UE 115 and the third UE 115 being able to access the reserved reservations when determining to which UE to transmit the conflict indication message (e.g., which UE 115 is the UE-B). The channel access parameters may be indicated in the SCI messages that reserve the overlapping resource(s). The first UE 115 may transmit a conflict indication message to the determined UE-B 115, and the UE-B 115 may select a different resource based on the conflict indication message.

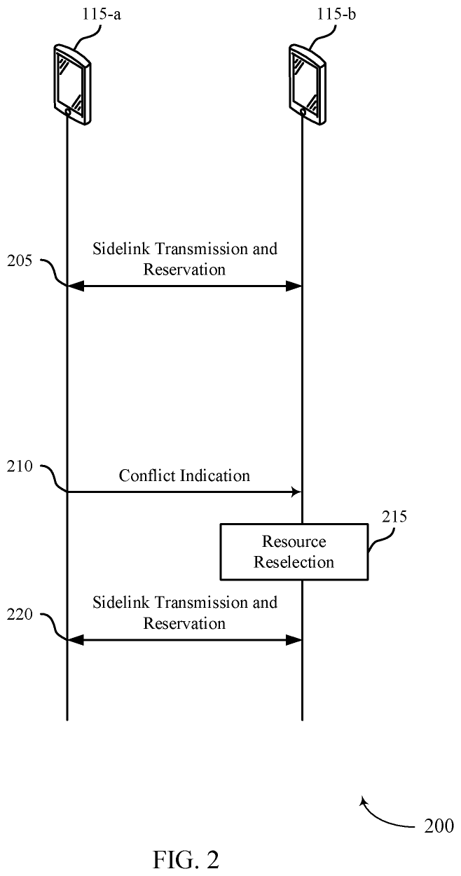

FIG. 2 illustrates an example of process flow 200 that supports inter-UE coordination in sidelink in accordance with one or more aspects of the present disclosure. The process flow 200 may include a first UE 115-a and a second UE 115-b, which may be examples of a UE 115 as described herein. In the following description of the process flow 200, the first UE 115-a and the second UE 115-b may be transmitted in a different order than the example order shown, or the operations performed by the first UE 115-a and the second UE 115-b may be performed in different orders or at different times. Some operations may also be omitted from the process flow 200, and other operations may be added to the process flow 200.

As described herein, in sidelink communications, a UE-A (e.g., the first UE 115-a) may send inter-UE coordination information about resource conflicts that a UE-B (e.g., the second UE 115-b) may incorporate into the UE-B's resource selection or reselection. The UE-A may indicate expected resource conflicts with the UE-B's reserved resources. The UE-A may be the recipient of at least one of the transport blocks (TB)s with conflicting reservations. Whether the non-destination UE of a TB transmitted by the UE-B may be the UE-A configured by the RRC parameter sl-TypeUE-A.

At 205, the first UE 115-a and the second UE 115-b may coordinate resource reservations by receiving and transmitting SCIs, which may reserve resources for transmissions of sidelink messages in TBs.

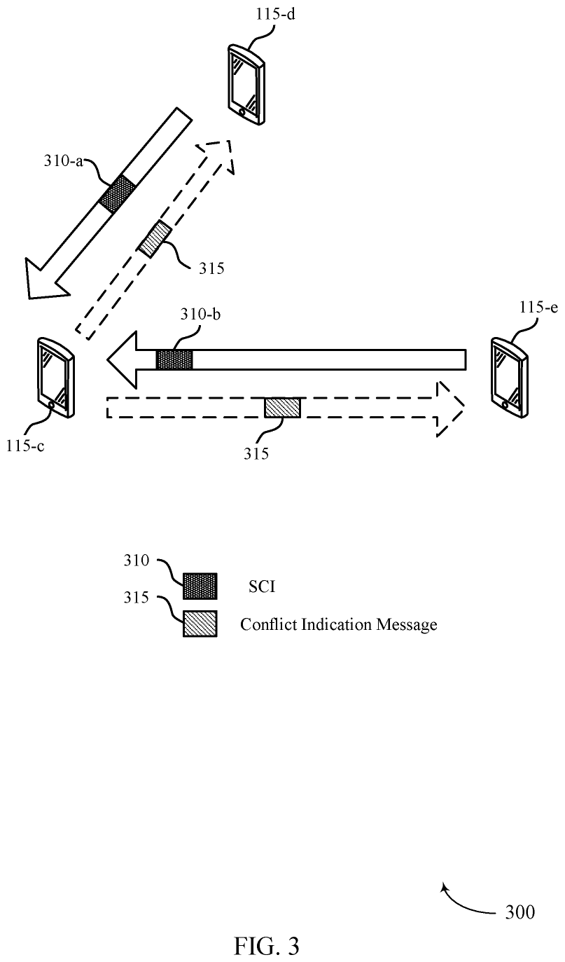

At 210, the first UE 115-a, as the UE-A, may transmit a conflict indication message to the second UE 115-b, which is a UE-B (e.g., the UE receiving the conflict indication message). In particular, the first UE 115-a as the UE-A may determine whether a conflict exists with the resource reservation indicated by the second UE 115-b. The first UE 115-a may receive TBs from other UEs 115 also indicating a resource reservation at the same or overlapping time and/or frequency resources as the second UE 115-b. For example, the first UE 115-a may receive an SCI message from the second UE 115-b that indicates reservation of a first resource. The first UE 115-a may also receive a second SCI message from a third UE 115 indicating reservation of a second resource, where the first and the second resources are overlapping in either time and/or frequency. An additional or alternative condition indicating a conflict, and as further discussed with respect to FIG. 3, may include when a reference signal received power (RSRP) of the transmission from UEs 115 (e.g., the second UE 115-b) to the first UE 115-a, the UE-A, is above a predetermined RSRP threshold. Another additional or alternative condition indicating a conflict may include when the difference between RSRPs of the transmissions to the first UE 115-a from the conflicting UEs 115 is above a predetermined RSRP difference threshold.

In addition to determining that there is a conflict, the first UE 115-a may determine to which UE 115 to send the conflict indication message. That is, the first UE 115-a as the UE-A, may determine the UE-B. The SCI messages may indicate whether or not a UE transmitting the SCI is capable of receiving a conflict indication message. For example, the first UE 115-a may determine that the second UE 115-b has a conflicting resource reservation and is capable of receiving a conflict indication message.

Selecting a UE 115 as the UE-B may also involve consideration of transmission priority, such that the UE-A may transmit the conflict indication message to the UE-B, which is designated based at least in part on a lower transmission priority than the other conflicting UE 115. The SCI message may also indicate a transmission priority associated with the UEs 115. For example, in the process flow 200, the second UE 115-b may have a lower priority than the third UE 115, which has the conflicting resource reservation with the second UE 115-b. As such, the first UE 115-a may transmit a conflict indication message to the second UE 115-b, which has a lower transmission priority than the first UE 115-a.

At 215, the second UE 115-b may reselect the resource or change the reservation based on receiving the conflict indication message. In particular, the conflict indication message received from the first UE 115-a may cause the second UE 115-b or include a request for the second UE 115-b to reselect a resource, in addition to or as an alternative to receiving the conflict indication message.

At 220, the first UE 115-a may receive (e.g., detect or sense) SCI messages. The second UE 115-b may transmit an SCI message, which may indicate information related to the new resource reservation. The first UE 115-a may continue monitoring for any additional conflict, for example, based on the new reserved resource for the second UE 115-b.

FIG. 3 illustrates an example of a wireless communication system 300 that supports inter-UE coordination in sidelink in accordance with one or more aspects of the present disclosure. The wireless communication system 300 may include a first UE 115-c, a second UE 115-d, and a third UE 115-e, which may be examples of a UE 115 as described herein.

In the wireless communication system 300, the first UE 115-c may receive an SCI 310-a from the second UE 115-d and an SCI 310-b from the third UE 115-e. The SCI 310-a and the SCI 310-b may include reservation information (e.g., time and/or frequency resource) for sidelink transmissions (e.g., one or more TBs) from the second UE 115-d and the third UE 115-e, respectively. The SCI 310-a and the SCI 310-b may indicate whether the respective UEs are able to receive conflict indication messages. The SCI 310-a and the SCI 310-b may also include transmission priorities associated with the resource reservations, and channel access parameters associated with the resource reservations. The channel access parameters may include, for example, an indication of a COT for the respective UEs 115, an indication of a channel sensing duration for the respective UEs 115, an indication of a CPE for the respective UEs 115, and/or number of retransmissions associated with the messages, associated with the respective resource reservations.

As described herein, the first UE 115-c, as the UE-A may send a conflict indication message 315 to either the second UE 115-d or the third UE 115-e as the determined UE-B. Based on the SCI messages (the SCI 310-a and the SCI 310-b), the first UE 115-c may determine whether there is a conflict between the resource reservations associated with the second UE 115-d and the third UE 115-e, as well as if the second UE 115-d and/or the third UE 115-e are able to receive the conflict indication messages 315.

In some examples, the first UE 115-c may determine whether a conflict exists based on one or more conditions. In some examples, the first UE 115-c may determine that a conflict exists when the RSRP measurements from a transmission (e.g., of the SCI 310-a and the SCI 310-b) are above a RSRP threshold. For example, if the first UE 115-c (e.g., UE-A) is an intended receiver of a physical sidelink shared channel (PSSCH) message from the second UE 115-d, the first UE 115-c may determine the resource conflict based on the RSRP of from the third UE 115-e being above a threshold (e.g., Th_{(p2, p1)}), where the threshold is related to the transmission priority of the second UE 115-d and the third UE 115-e. Similarly, if the first UE 115-a is an intended receiver of a PSSCH message from the third UE 115-e, the first UE 115-a may determine a resource conflict if the RSRP of the second UE 115-d is above a threshold, (e.g., Th_{(p2, p1)}). The threshold Th_{(p2, p1)} may be configured by RRC (e.g., from a network entity).

In some examples, the first UE 115-a may determine that a conflict exists based on when the difference between the RSRPs between the conflicting transmissions from the UEs (e.g., based the SCI 310-a and the SCI 310-b) to the first UE 115-c is above a RSRP difference threshold (e.g., differential RSRP measurement). For example, if the first UE 115-c (e.g., UE-A) is an intended receiver for a PSSCH message from the second UE 115-d, the first UE 115-c may determine a resource conflict if RSRP₂>RSRP₁+Delta_Th, where RSRP₁ and RSRP₂ are the RSRP measurements from the UE-A for the second UE 115-d and the third UE 115-e, respectively. Delta_Th may be configured by RRC signaling. Similarly, if the first UE 115-c (e.g., UE-A) is an intended receiver for a PSSCH message from the third UE 115-e, the first UE 115-c may determine a resource conflict if RSRP₁>RSRP₂+Delta_Th.

After determining whether the conflict exists based on the first and/or second conditions associated with RSRP measurements, and if the UEs 115 are able to receive conflict indication messages 315, the first UE 115-c may determine transmission priorities p1 and p2 associated with the second UE 115-d and the third UE 115-e, respectively. The first UE 115-c may transmit the conflict indication message 315 to the UE-B, which is the UE 115 with the lower transmission priority. If the second UE 115-d has the lower priority, then the first UE 115-c may transmit a conflict indication message 315 to the second UE 115-d. If the third UE 115-e has the lower priority, then the first UE 115-c may transmit the conflict indication message 315 to the third UE 115-e.

When the UE-B (e.g., the second UE 115-d or the third UE 115-e) receives a conflict indication message, the UE-B reports the resource conflict to higher layers, such as the MAC layer. In some examples, if a slotLevelResourceExclusionScheme2 information element is not provided, the UE-B may report resources overlapping with a next-in-time reserved resource indicated by the SCI message 310 (time-frequency resource collision). For example, the SCI message 310 may be an SCI format 1-A. In some examples, if a slotLevelResourceExclusionScheme2 information element is provided, the UE-B may report resources in a slot of a next-in-time reserved resource indicated by the SCI message 310 (half-duplex). The MAC layer at UE-B may reselect the reported resources (e.g., resource reselection) from the resources indicated by PHY layer excluding the reported resources.

However, as previously discussed, the transmission priorities, p₂, p₁, may be the same. To facilitate purposely selecting the UE 115 that may receive the conflict indication message 315, the first UE 115-c (e.g., the UE-A) may consider one or more channel access parameters. The channel access parameters may correspond to likelihood of transmission success for the reserved resource (e.g., a first reserved resource for the second UE 115-d and a second reserved resource for the third UE 115-e). As such, when the transmission priorities for the second UE 115-d and the third UE 115-e are the same, the first UE 115-c (e.g., UE-A) may strategically select either the second UE 115-d or the third UE 115-e as the UE 115 to receive the conflict indication message 315 (e.g., UE-B) since it has a lower probability of transmission success based on the one or more channel access parameters.

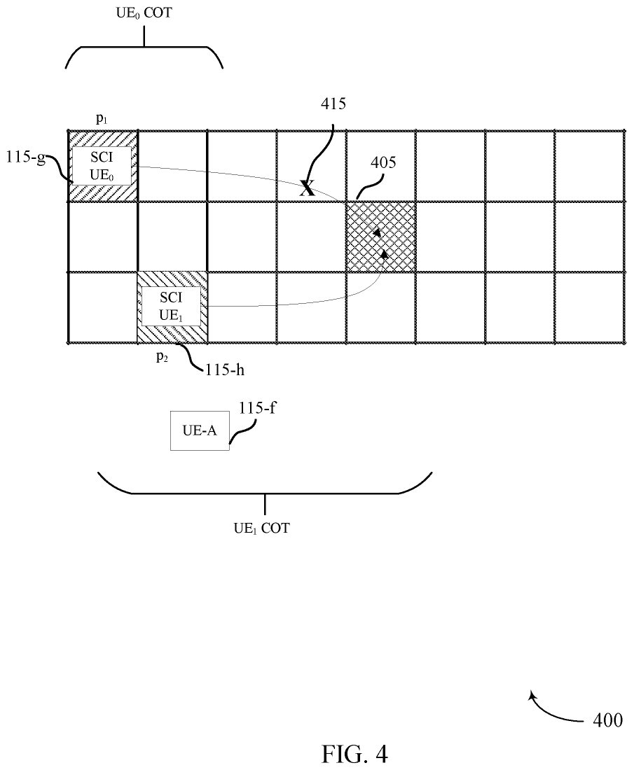

FIG. 4 illustrates an example of a resource diagram 400 in accordance with one or more aspects of the present disclosure. The resource diagram 400 may include a first UE 115-f, a second UE 115-g, and a third UE 115-h, which may be examples of a UE 115 as described herein.

In the resource diagram 400, the second UE 115-g and the third UE 115-h indicated may reserve a first resource and a second resource, respectively. For example, the second UE 115-g (UE₀) may transmit an SCI reserving the resource 405, and the third UE 115-h (UE₁) may transmit an SCI reserving the resource 405. The transmission priorities, p₂, p₁, which may be indicated by the respective SCIs, may be the same.

The first UE 115-f, which is the UE-A, may receive the SCI messages from the second UE 115-g and the third UE 115-h. The SCI messages may indicate the resource reservations (e.g., at the resource 405), priorities (e.g., pi for the second UE 115-g (UE₀) and p₂ for the third UE 115-h (UE₁)), and/or one or more channel access parameters. In some examples, if the sidelink communications are in an unlicensed spectrum, the second UE 115-g and the third UE 115-h may perform LBT procedures prior to transmitting on the reserved resources (e.g., the resource 405). The LBT patterns may impact channel access priority and resource utilization. For example, the LBT procedures for the UEs may indicate that the second UE 115-g and/or the third UE 115-h are associated with different likelihoods of being able to access the reserved resources based on multiple parameters (e.g., COT, CPE, channel sensing duration and/or number of retransmissions). Accordingly, random selection by the first UE 115-f (e.g., UE-A) of one of the second UE 115-g or third UE 115-h as the UE-B when transmission priorities are the same, may be inefficient (e.g., may lead to the resource 405 being unused if the UE that does not receive a conflict indication message is unable to pass LBT and access the channel).

The first UE 115-f (e.g., UE-A) may account for one or more of the channel access parameters to purposely or strategically select either the second UE 115-g or the third UE 115-h as the UE-B. The first UE 115-f (e.g., UE-A) may transmit the conflict indication message to the determined UE-B, and the UE-B in response to receiving the conflict indication message may reselect a resource (e.g., a different resource than the resource 405) for a PSSCH transmission. The other UE (the UE that did not receive the conflict indication message), may transmit a PSSCH transmission via the resource 405 (e.g., if the other UE 115 passes LBT). By considering the channel access parameters, which are indicative of the probability of successfully accessing a resource, the UE-A may facilitate continuing to reserve the first resource or the second resource for the second UE 115-g or the third UE 115-h, respectively, having the higher probability of successful channel access.

In some examples, the first UE 115-f (e.g., UE-A) may consider a COT parameter that is associated with the first resource reservation of the second UE 115-g and the second resource reservation of the third UE 115-h. For example, as indicated in the resource diagram 400, the reserved resource may be outside of the COT of the second UE 115-g or a shared COT to the second UE 115-g, and within the COT of the third UE 115-h or a shared COT to the third UE 115-h. If the reserved resource is outside the COT of its respective UE 115 or outside the COT shared to its respective UE 115, then the UE-A may send the conflict indication message 415 to the respective UE 115. For example, if the first reserved resource associated with the second UE 115-g is outside the COT of the second UE 115-g or outside a shared COT to the second UE 115-g while the second reserved resource associated with the third UE 115-h is within the COT of the third UE 115-h or within a shared COT to the third UE 115-h, then the first UE 115-f (e.g., UE-A) may send the conflict indication message 415 to the second UE 115-g. In some examples, if the COT information indicates that the reserved first and second resources are outside both of the respective COTs or inside both of the respective COTs, then the first UE 115-f may select either the second UE 115-g or the third UE 115-h as the UE-B to receive the conflict indication message 415. In some examples, the first UE 115-f may consider additional or alternative channel access parameters, for example, including the parameters discussed herein. Additionally, the COT information may be provided in the SCI messages received at the first UE 115-f from the second UE 115-g and the third UE 115-h.

In an LBT procedure, the UEs 115 measure radio frequency energy in a band and may transmit if the measured energy is below a threshold. UEs 115 may perform multiple types of LBT procedures, for example a category 2 LBT without random back-off or a category 4 LBT with random back-off with a contention window of variable size. The type of LBT procedure may depend on whether a transmission is without or outside of a COT for the UE 115. For in-COT transmission, a UE 115 may perform either a 25 μs or 16 μs category 2 LBT or no LBT, based on the gap between transmissions. For out of COT transmission, the UE may perform a category 4 LBT. A UE 115 may be more likely to pass a category 2 LBT procedure (or no LBT procedure), than a category 4 LBT, and accordingly, a UE 115 with a reserved resource within the COT for the UE 115 may be more likely to pass LBT and access the channel for the reserved resource than a UE 115 with a reserved resource outside the COT for the UE 115.

In some examples, the first UE 115-f (e.g., the UE-A) may consider the channel sensing duration that is associated with the first resource reservation and the second resource reservation. Sensing duration information may be provided in the SCI messages received by the first UE 115-f from the second UE 115-g and the third UE 115-h. A shorter channel sensing duration may correspond to a greater probability of success to access the channel since the channel may be cleared prior to transmission. Accordingly, if the first reserved resource of the second UE 115-g is associated with a first channel access type and the second reserved resource of the third UE 115-h is associated with a second channel access type, the first UE 115-f may select and transmit the conflict indication message 415 to the second UE 115-g associated with the first channel access type when the sensing duration of the first channel access type is longer (e.g., 25 μs) than the sensing duration of the second channel access type (e.g., 16 μs). That is, the first UE 115-f (e.g., UE-A) may transmit a conflict indication message 415 to the UE 115 corresponding to the largest sensing duration for the channel access type. A long channel sensing duration correlates to a low probability of being able to access the channel since the channel may be cleared before or during the sensing duration. Thus, the longer the sensing duration, the longer it may take to clear the channel before transmission. Thus, the UE 115 associated with the longest sensing duration is selected as the UE-B.

In some examples, if the sensing duration is the same for both channels associated with the second UE 115-g and the third UE 115-h, then the first UE 115-f may select either the second UE 115-g or the third UE 115-h as the UE-B to receive the conflict indication message 415. In some examples, the first UE 115-f may consider additional or alternative channel access parameters when the sensing duration is the same, for example, including the parameters discussed herein.

In some examples, the first UE 115-f (e.g., UE-A) may consider the CPE that is associated with the first resource reservation and the second resource reservation. Generally, the first UE 115-f may select the UE 115 associated with the shortest CPE as the UE-B. As such, if the first reserved resource of the second UE 115-g is associated with a first CPE and the second reserved resource of the third UE 115-h is associated with a second CPE, the first UE 115-f may select and transmit the conflict indication message 415 to the second UE 115-g associated with the first CPE when the CPE of the second UE 115-g is smaller than the CPE of the third UE 115-h. That is, the first UE 115-f (e.g., UE-A) may transmit the conflict indication message 415 to the UE 115 corresponding to the shortest CPE. The CPE length inversely correlates to a transmission starting point and an early transmission starting point corresponds to greater probability for accessing the channel. In some examples, an automatic gain control (AGC) puncture may be applied to adjust for interference, and the AGC puncture may occur before the CPE.

In some examples, if the CPE is the same for both channels associated with the second UE 115-g and the third UE 115-h, then the first UE 115-f may select either the second UE 115-g or the third UE 115-h as the UE-B to receive the conflict indication message 415. In some examples, the first UE 115-f may consider additional or alternative channel access parameters when the CPEs are the same, for example, including the parameters discussed herein. Additionally, or alternatively, the CPE information may be provided in the SCI messages received at the first UE 115-f from the second UE 115-g and the third UE 115-h.

In some examples, the first UE 115-f (e.g., UE-A) may consider the number (e.g., N₁, N₂) of retransmissions (e.g., HARQ retransmission) associated with the first resource reservation and the second resource reservation. For example, the first UE 115-a may select the UE 115 associated with the smallest number of retransmissions to the reserved resource as the UE-B. A large number of retransmissions may correspond to a small packet delay budget. As such, the first UE 115-f may send the conflict indication message 415 to the UE 115 with the greatest packet delay budget to prioritize the large number of retransmissions. If the first reserved resource of the second UE 115-g is associated with a first number of retransmission and the second reserved resource of the third UE 115-h is associated with a second number of retransmissions, the first UE 115-f may select and transmit the conflict indication message 415 to the second UE 115-g associated with the first number of transmission when the first number of retransmission is smaller than the second number of retransmissions of the third UE 115-h. That is, the first UE 115-f (e.g., UE-A) may transmit the conflict indication message 415 to the UE 115 corresponding to the smallest number of retransmissions, for example, to prioritize transmission for the other UE 115 that has a smaller packet delay budget.

In some examples, if the number of retransmissions is the same for both channels associated with the second UE 115-g and the third UE 115-h, then the first UE 115-f may select either the second UE 115-g or the third UE 115-h as the UE-B to receive the conflict indication message 415. In some examples, the first UE 115-f may consider additional or alternative channel access parameters when the number of retransmissions is the same, for example, including the parameters discussed herein. Additionally, the retransmission information may be provided in the SCI messages received at the first UE 115-f from the second UE 115-g and the third UE 115-h. For example, the first UE 115-f may determine N₁ and N₂ via a second stage SCI (also referred to as SCI-2). An SCI-2 may be transmitted and received via a PSSCH, and a first-stage SCI (also referred to as an SCI-1) may be transmitted and received in a physical sidelink control channel (PSCCH). The SCI message may indicate a HARQ process number, a new data indicator, transmission identification (ID) and destination ID. The number of TBs transmitted may correspond to the number the retransmissions.

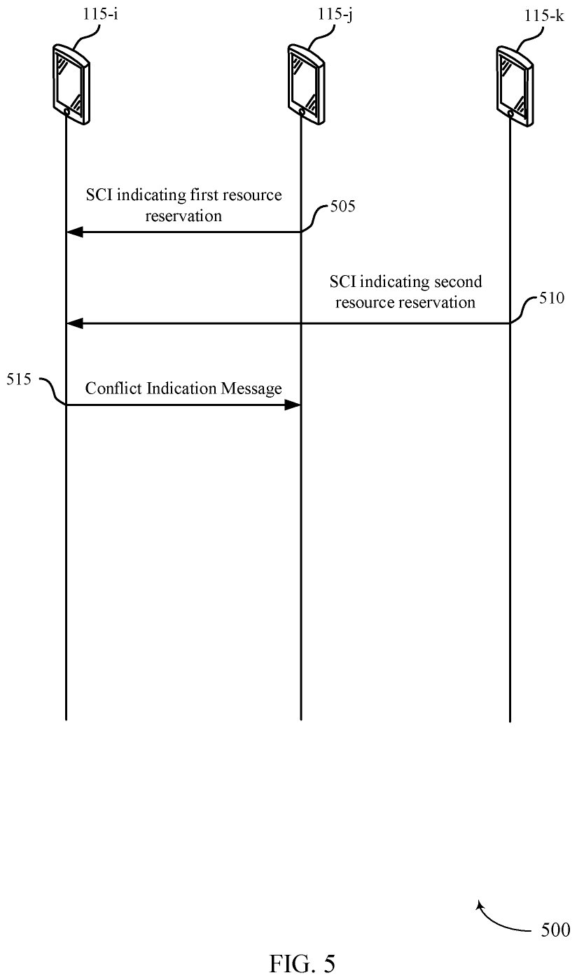

FIG. 5 illustrates an example of a process flow 500 that supports inter-UE coordination in sidelink in accordance with one or more aspects of the present disclosure. The process flow 500 may include a first UE 115-i, a second UE 115-j, and a third UE 115-k, which may be examples of a UE 115 as described herein. In the following description of the process flow 500, the first UE 115-i, the second UE 115-j, and the third UE 115-k may be transmitted in a different order than the example order shown, or the operations performed by the first UE 115-i, the second UE 115-j, and the third UE 115-k may be performed in different orders or at different times. Some operations may also be omitted from the process flow 500, and other operations may be added to the process flow 500.

At 505, the first UE 115-i may receive, from the second UE 115-j, a first SCI message indicative of a first resource reservation and a first parameter.

At 510, the first UE 115-i may receive, from the second UE 115-j, a second SCI message indicative of a second resource reservation and a second parameter, where the second resource reservation at least partially overlaps with the first resource reservation. In some examples, the second resource reservation at least partially overlaps with the first resource reservation in the time domain, the frequency domain, or a combination thereof.

At 515, the first UE 115-i may transmit, to one of the second UE 115-j or the third UE 115-k, a conflict indication message in accordance with a conflict reporting scheme indicating to transmit the conflict indication message to one of the second UE 115-j or the third UE 115-k based on the first parameter and the second parameter.

In some examples, transmitting the conflict indication message includes transmitting the conflict indication message to the second UE 115-j based on a first probability of channel access to the first resource reservation being less than a second probability of channel access to the second resource reservation in accordance with the conflict reporting scheme, where the first parameter corresponds to the first probability of channel access to the first resource reservation, and where the second parameter corresponds to the second probability of channel access to the second resource reservation.

In some examples, the first SCI message indicates a first priority, the second SCI message indicates a second priority equal to the first priority, and transmitting the conflict indication message is based on the second priority being equal to the first priority.

In some examples, the first SCI message indicates the first resource reservation is outside a first COT for the second UE 115-j, the second SCI message indicates the second resource reservation is within a second COT for the third UE 115-k, and transmitting the conflict indication message includes transmitting the conflict indication message to the second UE 115-j based on the first resource reservation being outside the first COT and the second resource reservation being within the second COT in accordance with the conflict reporting scheme.

In some examples, the first SCI message indicates a first channel access type associated with a first channel sensing duration, the second SCI message indicates a second channel access type associated with a second channel sensing duration, and transmitting the conflict indication message includes transmitting the conflict indication message to the second UE 115-j based on the first channel sensing duration being longer than the second channel sensing duration in accordance with the conflict reporting scheme.

In some examples, the first SCI message indicates a first CPE associated with the first resource reservation, the second SCI message indicates a second CPE associated with the second resource reservation, and transmitting the conflict indication message includes transmitting the conflict indication message to the second UE 115-j based on the first CPE being shorter than the second CPE in accordance with the conflict reporting scheme.

In some examples, the first SCI message indicates a first HARQ retransmission number associated with the first resource reservation, the second SCI message indicates a second HARQ retransmission number associated with the second resource reservation, and transmitting the conflict indication message includes transmitting the conflict indication message to the second UE 115-j based on the first HARQ retransmission number being less than the second HARQ retransmission number in accordance with the conflict reporting scheme.

In some examples, the first UE 115-i transmits the conflict indication message via a sidelink feedback channel (e.g., a PSFCH).

In some examples, the first UE 115-i may receive a sidelink message from the third UE 115-k in accordance with the second resource reservation, where the first UE 115-i transmitted the conflict indication message to the second UE 115-j.

In some examples, the first UE 115-i may receive control signaling indicating the conflict reporting scheme (e.g., RRC signaling from a network entity).

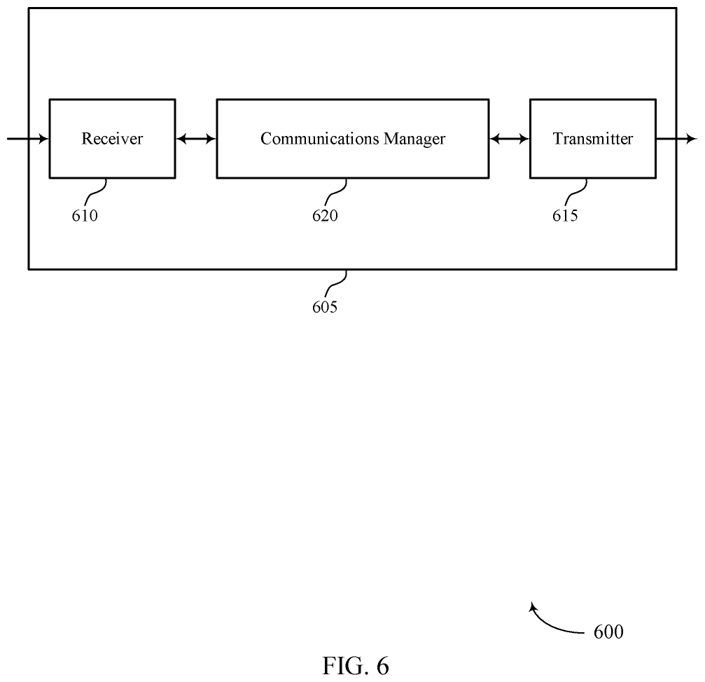

FIG. 6 shows a block diagram 600 of a device 605 that supports inter-UE coordination in sidelink in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to inter-UE coordination in sidelink). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inter-UE coordination in sidelink). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of inter-UE coordination in sidelink as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first UE in accordance with examples as disclosed herein. For example, the communications manager 620 may be configured as or otherwise support a means for receiving, from a second UE, a first SCI message indicative of a first resource reservation and a first parameter. The communications manager 620 may be configured as or otherwise support a means for receiving, from a third UE, a second SCI message indicative of a second resource reservation and a second parameter, where the second resource reservation at least partially overlaps with the first resource reservation. The communications manager 620 may be configured as or otherwise support a means for transmitting, to one of the second UE or the third UE, a conflict indication message in accordance with a conflict reporting scheme indicating to transmit the conflict indication message to one of the second UE or the third UE based on the first parameter and the second parameter.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

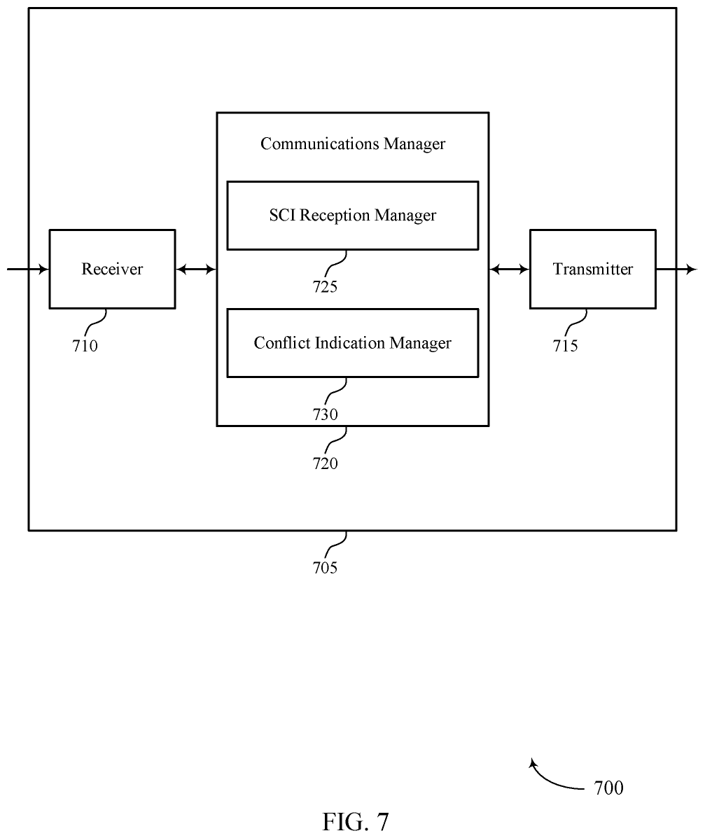

FIG. 7 shows a block diagram 700 of a device 705 that supports inter-UE coordination in sidelink in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to inter-UE coordination in sidelink). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to inter-UE coordination in sidelink). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of inter-UE coordination in sidelink as described herein. For example, the communications manager 720 may include an SCI reception manager 725 a conflict indication manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first UE in accordance with examples as disclosed herein. The SCI reception manager 725 may be configured as or otherwise support a means for receiving, from a second UE, a first SCI message indicative of a first resource reservation and a first parameter. The SCI reception manager 725 may be configured as or otherwise support a means for receiving, from a third UE, a second SCI message indicative of a second resource reservation and a second parameter, where the second resource reservation at least partially overlaps with the first resource reservation. The conflict indication manager 730 may be configured as or otherwise support a means for transmitting, to one of the second UE or the third UE, a conflict indication message in accordance with a conflict reporting scheme indicating to transmit the conflict indication message to one of the second UE or the third UE based on the first parameter and the second parameter.

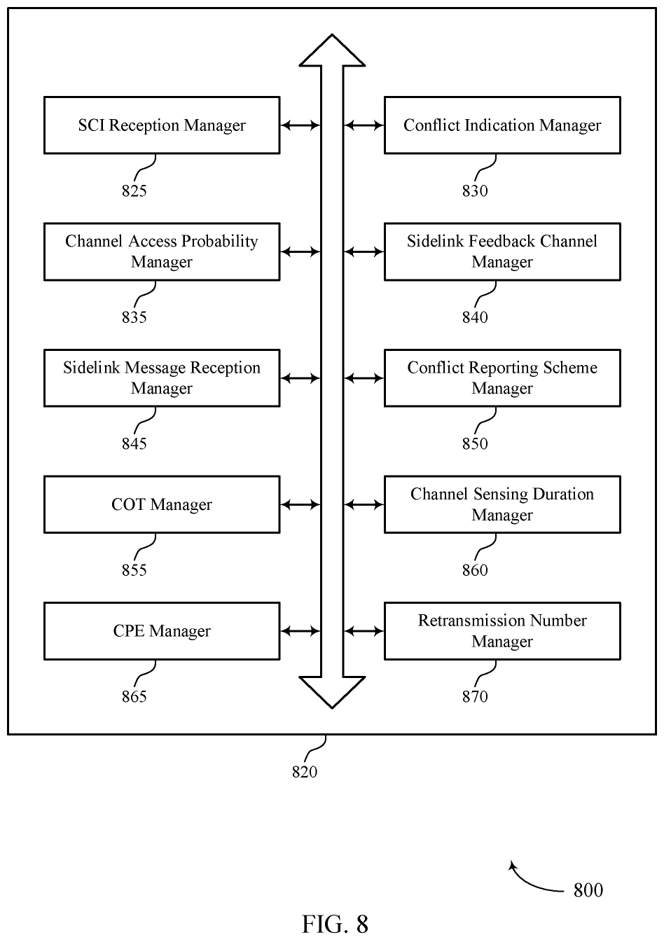

FIG. 8 shows a block diagram 800 of a communications manager 820 that supports inter-UE coordination in sidelink in accordance with one or more aspects of the present disclosure. The communications manager 820 may be an example of aspects of a communications manager 620, a communications manager 720, or both, as described herein. The communications manager 820, or various components thereof, may be an example of means for performing various aspects of inter-UE coordination in sidelink as described herein. For example, the communications manager 820 may include an SCI reception manager 825, a conflict indication manager 830, a channel access probability manager 835, a sidelink feedback channel manager 840, a sidelink message reception manager 845, a conflict reporting scheme manager 850, a COT manager 855, a channel sensing duration manager 860, a CPE manager 865, a retransmission number manager 870, or any combination thereof. Each of these components may communicate, directly or indirectly, with one another (e.g., via one or more buses).

The communications manager 820 may support wireless communications at a first UE in accordance with examples as disclosed herein. The SCI reception manager 825 may be configured as or otherwise support a means for receiving, from a second UE, a first SCI message indicative of a first resource reservation and a first parameter. In some examples, the SCI reception manager 825 may be configured as or otherwise support a means for receiving, from a third UE, a second SCI message indicative of a second resource reservation and a second parameter, where the second resource reservation at least partially overlaps with the first resource reservation. The conflict indication manager 830 may be configured as or otherwise support a means for transmitting, to one of the second UE or the third UE, a conflict indication message in accordance with a conflict reporting scheme indicating to transmit the conflict indication message to one of the second UE or the third UE based on the first parameter and the second parameter.

In some examples, to support transmitting the conflict indication message, the channel access probability manager 835 may be configured as or otherwise support a means for transmitting the conflict indication message to the second UE based on a first probability of channel access to the first resource reservation being less than a second probability of channel access to the second resource reservation in accordance with the conflict reporting scheme, where the first parameter corresponds to the first probability of channel access to the first resource reservation, and where the second parameter corresponds to the second probability of channel access to the second resource reservation.

In some examples, the first SCI message indicates a first priority. In some examples, the second SCI message indicates a second priority equal to the first priority. In some examples, transmitting the conflict indication message is based on the second priority being equal to the first priority.

In some examples, where the first SCI message indicates the first resource reservation is outside a first COT for the second UE, and where the second SCI message indicates the second resource reservation is within a second COT for the third UE, to support transmitting the conflict indication message, the COT manager 855 may be configured as or otherwise support a means for transmitting the conflict indication message to the second UE based on the first resource reservation being outside the first COT and the second resource reservation being within the second COT in accordance with the conflict reporting scheme.

In some examples, where the first SCI message indicates a first channel access type associated with a first channel sensing duration, and where the second SCI message indicates a second channel access type associated with a second channel sensing duration, to support transmitting the conflict indication message, the channel sensing duration manager 860 may be configured as or otherwise support a means for transmitting the conflict indication message to the second UE based on the first channel sensing duration being longer than the second channel sensing duration in accordance with the conflict reporting scheme.

In some examples, where the first SCI message indicates a first CPE associated with the first resource reservation, and where the second SCI message indicates a second CPE associated with the second resource reservation, to support transmitting the conflict indication message, the CPE manager 865 may be configured as or otherwise support a means for transmitting the conflict indication message to the second UE based on the first CPE being shorter than the second CPE in accordance with the conflict reporting scheme.

In some examples, where the first SCI message indicates a first HARQ retransmission number associated with the first resource reservation, and where the second SCI message indicates a second HARQ retransmission number associated with the second resource reservation, to support transmitting the conflict indication message, the retransmission number manager 870 may be configured as or otherwise support a means for transmitting the conflict indication message to the second UE based on the first HARQ retransmission number being less than the second HARQ retransmission number in accordance with the conflict reporting scheme.

In some examples, the second resource reservation at least partially overlaps with the first resource reservation in the time domain, the frequency domain, or a combination thereof.

In some examples, to support transmitting the conflict indication message, the sidelink feedback channel manager 840 may be configured as or otherwise support a means for transmitting the conflict indication message via a sidelink feedback channel.

In some examples, the sidelink message reception manager 845 may be configured as or otherwise support a means for receiving a sidelink message from the third UE in accordance with the second resource reservation, where transmitting the conflict indication message includes transmitting the conflict indication message to the second UE.

In some examples, the conflict reporting scheme manager 850 may be configured as or otherwise support a means for receiving control signaling indicating the conflict reporting scheme.

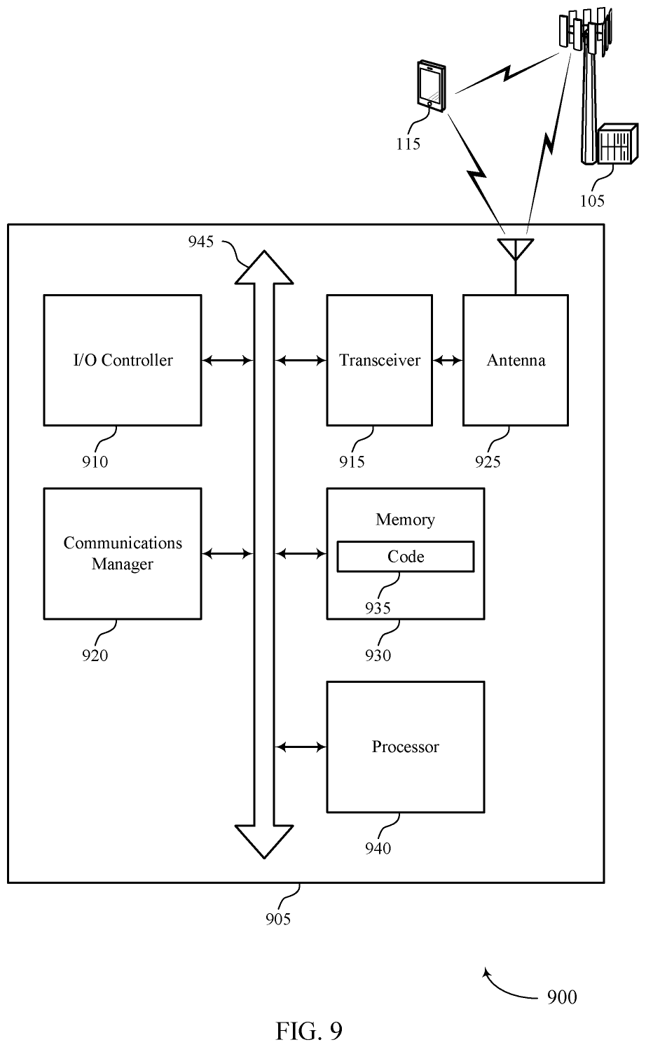

FIG. 9 shows a diagram of a system 900 including a device 905 that supports inter-UE coordination in sidelink in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting inter-UE coordination in sidelink). For example, the device 905 or a component of the device 905 may include a processor 940 and memory 930 coupled with or to the processor 940, the processor 940 and memory 930 configured to perform various functions described herein.

The communications manager 920 may support wireless communications at a first UE in accordance with examples as disclosed herein. For example, the communications manager 920 may be configured as or otherwise support a means for receiving, from a second UE, a first SCI message indicative of a first resource reservation and a first parameter. The communications manager 920 may be configured as or otherwise support a means for receiving, from a third UE, a second SCI message indicative of a second resource reservation and a second parameter, where the second resource reservation at least partially overlaps with the first resource reservation. The communications manager 920 may be configured as or otherwise support a means for transmitting, to one of the second UE or the third UE, a conflict indication message in accordance with a conflict reporting scheme indicating to transmit the conflict indication message to one of the second UE or the third UE based on the first parameter and the second parameter.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of inter-UE coordination in sidelink as described herein, or the processor 940 and the memory 930 may be otherwise configured to perform or support such operations.

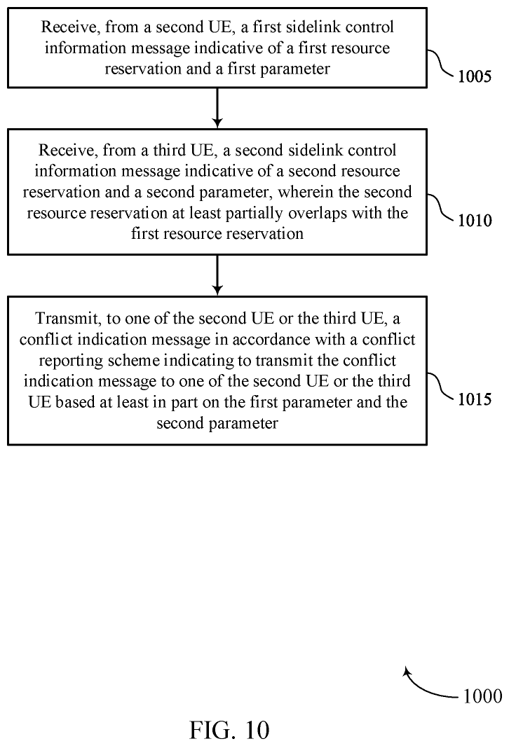

FIG. 10 shows a flowchart illustrating a method 1000 that supports inter-UE coordination in sidelink in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving, from a second UE, a first SCI message indicative of a first resource reservation and a first parameter. The operations of 1005 may be performed in accordance with examples as disclosed herein. In some examples, aspects of the operations of 1005 may be performed by an SCI reception manager 825 as described with reference to FIG. 8.

At 1010, the method may include receiving, from a third UE, a second SCI message indicative of a second resource reservation and a second parameter, where the second resource reservation at least partially overlaps with the first resource reservation. The operations of 1010 may be performed in accordance with examples as disclosed herein. In some examples, aspects of the operations of 1010 may be performed by an SCI reception manager 825 as described with reference to FIG. 8.

At 1015, the method may include transmitting, to one of the second UE or the third UE, a conflict indication message in accordance with a conflict reporting scheme indicating to transmit the conflict indication message to one of the second UE or the third UE based on the first parameter and the second parameter. The operations of 1015 may be performed in accordance with examples as disclosed herein. In some examples, aspects of the operations of 1015 may be performed by a conflict indication manager 830 as described with reference to FIG. 8.

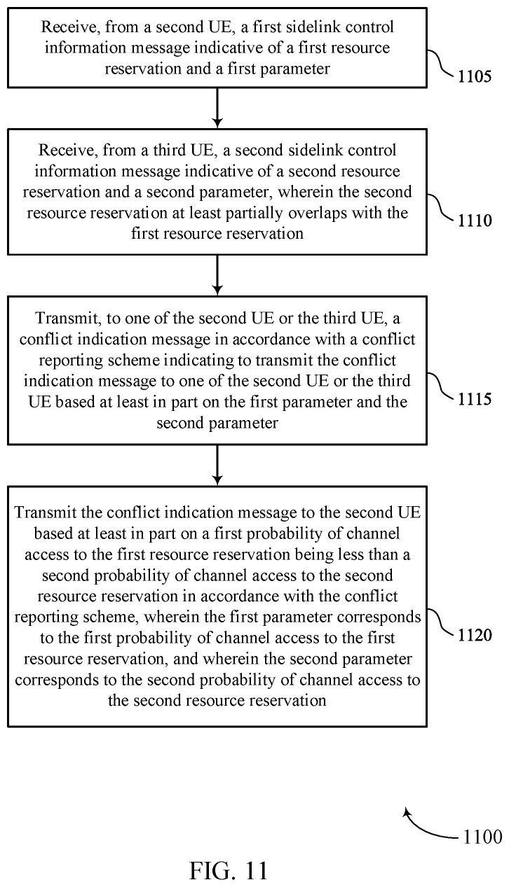

FIG. 11 shows a flowchart illustrating a method 1100 that supports inter-UE coordination in sidelink in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving, from a second UE, a first SCI message indicative of a first resource reservation and a first parameter. The operations of 1105 may be performed in accordance with examples as disclosed herein. In some examples, aspects of the operations of 1105 may be performed by an SCI reception manager 825 as described with reference to FIG. 8.

At 1110, the method may include receiving, from a third UE, a second SCI message indicative of a second resource reservation and a second parameter, where the second resource reservation at least partially overlaps with the first resource reservation. The operations of 1110 may be performed in accordance with examples as disclosed herein. In some examples, aspects of the operations of 1110 may be performed by an SCI reception manager 825 as described with reference to FIG. 8.

At 1115, the method may include transmitting, to one of the second UE or the third UE, a conflict indication message in accordance with a conflict reporting scheme indicating to transmit the conflict indication message to one of the second UE or the third UE based on the first parameter and the second parameter. The operations of 1115 may be performed in accordance with examples as disclosed herein. In some examples, aspects of the operations of 1115 may be performed by a conflict indication manager 830 as described with reference to FIG. 8.

At 1120, the method may include transmitting the conflict indication message to the second UE based on a first probability of channel access to the first resource reservation being less than a second probability of channel access to the second resource reservation in accordance with the conflict reporting scheme, where the first parameter corresponds to the first probability of channel access to the first resource reservation, and where the second parameter corresponds to the second probability of channel access to the second resource reservation. The operations of 1120 may be performed in accordance with examples as disclosed herein. In some examples, aspects of the operations of 1120 may be performed by a channel access probability manager 835 as described with reference to FIG. 8.

The following provides an overview of aspects of the present disclosure:

Aspect 1: A method for wireless communications at a first UE, comprising: receiving, from a second UE, a first SCI message indicative of a first resource reservation and a first parameter; receiving, from a third UE, a second SCI message indicative of a second resource reservation and a second parameter, wherein the second resource reservation at least partially overlaps with the first resource reservation; and transmitting, to one of the second UE or the third UE, a conflict indication message in accordance with a conflict reporting scheme indicating to transmit the conflict indication message to one of the second UE or the third UE based at least in part on the first parameter and the second parameter.

Aspect 2: The method of aspect 1, wherein transmitting the conflict indication message comprises: transmitting the conflict indication message to the second UE based at least in part on a first probability of channel access to the first resource reservation being less than a second probability of channel access to the second resource reservation in accordance with the conflict reporting scheme, wherein the first parameter corresponds to the first probability of channel access to the first resource reservation, and wherein the second parameter corresponds to the second probability of channel access to the second resource reservation.

Aspect 3: The method of any of aspects 1 through 2, wherein the first SCI message indicates a first priority, the second SCI message indicates a second priority equal to the first priority, and transmitting the conflict indication message is based at least in part on the second priority being equal to the first priority.

Aspect 4: The method of aspect 3, wherein the first SCI message indicates the first resource reservation is outside a first COT for the second UE, wherein the second SCI message indicates the second resource reservation is within a second COT for the third UE, and wherein transmitting the conflict indication message comprises: transmitting the conflict indication message to the second UE based at least in part on the first resource reservation being outside the first COT and the second resource reservation being within the second COT in accordance with the conflict reporting scheme.

Aspect 5: The method of claim 3, wherein the first SCI message indicates a first channel access type associated with a first channel sensing duration, wherein the second SCI message indicates a second channel access type associated with a second channel sensing duration, and wherein transmitting the conflict indication message comprises: transmitting the conflict indication message to the second UE based at least in part on the first channel sensing duration being longer than the second channel sensing duration in accordance with the conflict reporting scheme.

Aspect 6: The method of any of aspects 3 through 5, wherein the first SCI message indicates a first CPE associated with the first resource reservation, wherein the second SCI message indicates a second CPE associated with the second resource reservation, and wherein transmitting the conflict indication message comprises: transmitting the conflict indication message to the second UE based at least in part on the first CPE being shorter than the second CPE in accordance with the conflict reporting scheme.

Aspect 7: The method of any of aspects 3 through 6, wherein the first SCI message indicates a first HARQ retransmission number associated with the first resource reservation, wherein the second SCI message indicates a second HARQ retransmission number associated with the second resource reservation, and wherein transmitting the conflict indication message comprises: transmitting the conflict indication message to the second UE based at least in part on the first HARQ retransmission number being less than the second HARQ retransmission number in accordance with the conflict reporting scheme.

Aspect 8: The method of any of aspects 1 through 7, wherein the second resource reservation at least partially overlaps with the first resource reservation in the time domain, the frequency domain, or a combination thereof.

Aspect 9: The method of any of aspects 1 through 8, wherein transmitting the conflict indication message comprises: transmitting the conflict indication message via a sidelink feedback channel.

Aspect 10: The method of any of aspects 1 through 9, further comprising: receiving a sidelink message from the third UE in accordance with the second resource reservation, wherein transmitting the conflict indication message comprises transmitting the conflict indication message to the second UE.

Aspect 11: The method of any of aspects 1 through 10, further comprising: receiving control signaling indicating the conflict reporting scheme.

Aspect 12: An apparatus for wireless communications at a first UE, comprising a processor; memory coupled with the processor; and instructions stored in the memory and executable by the processor to cause the apparatus to perform a method of any of aspects 1 through 11.

Aspect 13: An apparatus for wireless communications at a first UE, comprising at least one means for performing a method of any of aspects 1 through 11.

Aspect 14: A non-transitory computer-readable medium storing code for wireless communications at a first UE, the code comprising instructions executable by a processor to perform a method of any of aspects 1 through 11.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a first user equipment (UE), comprising:
receiving, from a second UE, a first sidelink control information message indicative of a first resource reservation and a first parameter;
receiving, from a third UE, a second sidelink control information message indicative of a second resource reservation and a second parameter, wherein the second resource reservation at least partially overlaps with the first resource reservation; and
transmitting, to one of the second UE or the third UE, a conflict indication message in accordance with a conflict reporting scheme indicating to transmit the conflict indication message to one of the second UE or the third UE based at least in part on the first parameter and the second parameter.

2. The method of claim 1, wherein transmitting the conflict indication message comprises:
transmitting the conflict indication message to the second UE based at least in part on a first probability of channel access to the first resource reservation being less than a second probability of channel access to the second resource reservation in accordance with the conflict reporting scheme, wherein the first parameter corresponds to the first probability of channel access to the first resource reservation, and wherein the second parameter corresponds to the second probability of channel access to the second resource reservation.

3. The method of claim 1, wherein:
the first sidelink control information message indicates a first priority,
the second sidelink control information message indicates a second priority equal to the first priority, and
transmitting the conflict indication message is based at least in part on the second priority being equal to the first priority.

4. The method of claim 3, wherein the first sidelink control information message indicates the first resource reservation is outside a first channel occupancy time for the second UE, wherein the second sidelink control information message indicates the second resource reservation is within a second channel occupancy time for the third UE, and wherein transmitting the conflict indication message comprises:
transmitting the conflict indication message to the second UE based at least in part on the first resource reservation being outside the first channel occupancy time and the second resource reservation being within the second channel occupancy time in accordance with the conflict reporting scheme.

5. The method of claim 3, wherein the first sidelink control information message indicates a first channel access type associated with a first channel sensing duration, wherein the second sidelink control information message indicates a second channel access type associated with a second channel sensing duration, and wherein transmitting the conflict indication message comprises:
transmitting the conflict indication message to the second UE based at least in part on the first channel sensing duration being longer than the second channel sensing duration in accordance with the conflict reporting scheme.

6. The method of claim 3, wherein the first sidelink control information message indicates a first cyclic prefix extension associated with the first resource reservation, wherein the second sidelink control information message indicates a second cyclic prefix extension associated with the second resource reservation, and wherein transmitting the conflict indication message comprises:
transmitting the conflict indication message to the second UE based at least in part on the first cyclic prefix extension being shorter than the second cyclic prefix extension in accordance with the conflict reporting scheme.

7. The method of claim 3, wherein the first sidelink control information message indicates a first hybrid automatic repeat request retransmission number associated with the first resource reservation, wherein the second sidelink control information message indicates a second hybrid automatic repeat request retransmission number associated with the second resource reservation, and wherein transmitting the conflict indication message comprises:
transmitting the conflict indication message to the second UE based at least in part on the first hybrid automatic repeat request retransmission number being less than the second hybrid automatic repeat request retransmission number in accordance with the conflict reporting scheme.

8. The method of claim 1, wherein the second resource reservation at least partially overlaps with the first resource reservation in a time domain, a frequency domain, or a combination thereof.

9. The method of claim 1, wherein transmitting the conflict indication message comprises:
transmitting the conflict indication message via a sidelink feedback channel.

10. The method of claim 1, further comprising:
receiving a sidelink message from the third UE in accordance with the second resource reservation, wherein transmitting the conflict indication message comprises transmitting the conflict indication message to the second UE.

11. The method of claim 1, further comprising:
receiving control signaling indicating the conflict reporting scheme.

12. An apparatus for wireless communications at a first user equipment (UE), comprising:
a processor;
memory coupled with the processor; and
instructions stored in the memory and executable by the processor to cause the apparatus to:
receive, from a second UE, a first sidelink control information message indicative of a first resource reservation and a first parameter;
receive, from a third UE, a second sidelink control information message indicative of a second resource reservation and a second parameter, wherein the second resource reservation at least partially overlaps with the first resource reservation; and
transmit, to one of the second UE or the third UE, a conflict indication message in accordance with a conflict reporting scheme indicating to transmit the conflict indication message to one of the second UE or the third UE based at least in part on the first parameter and the second parameter.

13. The apparatus of claim 12, wherein the instructions to transmit the conflict indication message are executable by the processor to cause the apparatus to:
transmit the conflict indication message to the second UE based at least in part on a first probability of channel access to the first resource reservation being less than a second probability of channel access to the second resource reservation in accordance with the conflict reporting scheme, wherein the first parameter corresponds to the first probability of channel access to the first resource reservation, and wherein the second parameter corresponds to the second probability of channel access to the second resource reservation.

14. The apparatus of claim 12, wherein:
the first sidelink control information message indicates a first priority,
the second sidelink control information message indicates a second priority equal to the first priority, and
transmitting the conflict indication message is based at least in part on the second priority being equal to the first priority.

15. The apparatus of claim 14, wherein the first sidelink control information message indicates the first resource reservation is outside a first channel occupancy time for the second UE, wherein the second sidelink control information message indicates the second resource reservation is within a second channel occupancy time for the third UE, and wherein the instructions to transmit the conflict indication message are executable by the processor to cause the apparatus to:
transmit the conflict indication message to the second UE based at least in part on the first resource reservation being outside the first channel occupancy time and the second resource reservation being within the second channel occupancy time in accordance with the conflict reporting scheme.

16. The apparatus of claim 14, wherein the first sidelink control information message indicates a first channel access type associated with a first channel sensing duration, wherein the second sidelink control information message indicates a second channel access type associated with a second channel sensing duration, and wherein the instructions to transmit the conflict indication message are executable by the processor to cause the apparatus to:
transmit the conflict indication message to the second UE based at least in part on the first channel sensing duration being longer than the second channel sensing duration in accordance with the conflict reporting scheme.

17. The apparatus of claim 14, wherein the first sidelink control information message indicates a first cyclic prefix extension associated with the first resource reservation, wherein the second sidelink control information message indicates a second cyclic prefix extension associated with the second resource reservation, and wherein the instructions to transmit the conflict indication message are executable by the processor to cause the apparatus to:
transmit the conflict indication message to the second UE based at least in part on the first cyclic prefix extension being shorter than the second cyclic prefix extension in accordance with the conflict reporting scheme.

18. The apparatus of claim 14, wherein the first sidelink control information message indicates a first hybrid automatic repeat request retransmission number associated with the first resource reservation, wherein the second sidelink control information message indicates a second hybrid automatic repeat request retransmission number associated with the second resource reservation, and wherein the instructions to transmit the conflict indication message are executable by the processor to cause the apparatus to:
transmit the conflict indication message to the second UE based at least in part on the first hybrid automatic repeat request retransmission number being less than the second hybrid automatic repeat request retransmission number in accordance with the conflict reporting scheme.

19. The apparatus of claim 12, wherein the second resource reservation at least partially overlaps with the first resource reservation in a time domain, a frequency domain, or a combination thereof.

20. The apparatus of claim 12, wherein the instructions to transmit the conflict indication message are executable by the processor to cause the apparatus to:
transmit the conflict indication message via a sidelink feedback channel.

21-30. (canceled)
